(19) United States
(12) Patent Application Publication
(10) Pub. No.: US 2025/0039669 A1
(43) Pub. Date: Jan. 30, 2025

(54) AUTHENTICATION IN ACCESS NETWORK SHARING ENVIRONMENT

(71) Applicant: Nokia Technologies Oy, Espoo (FI)

(72) Inventors: Suresh P NAIR, Estero, FL (US); Rakshesh PRAVINCHANDRA BHATT, Bangalore (IN); Divya G NAIR, Bangalore (IN); Ranganathan MAVUREDDI DHANASEKARAN, Munich (DE)

(21) Appl. No.: 18/782,737

(22) Filed: Jul. 24, 2024

(30) Foreign Application Priority Data
Jul. 26, 2023 (IN) 202311050329

(51) Int. Cl. H04W 12/069; H04W 12/041; H04W 76/10

(52) U.S. Cl. CPC H04W 12/069; H04W 12/041; H04W 76/10

(57) ABSTRACT

Techniques are disclosed for user equipment authentication in a shared access network environment. In one example, a method comprises establishing, via a first access management entity in a first communication network that has a radio access network associated therewith, a secure connection with a second access management entity in a second communication network to which user equipment subscribes, and facilitating, via the first access management entity, authentication of the user equipment in conjunction with the second access management entity over the secure connection to enable the user equipment to utilize the radio access network of the first communication network to access the second communication network.

### FIELD

The field relates generally to communication networks, and more particularly, but not exclusively, to security management in such communication networks.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

Fourth generation (4G) wireless mobile telecommunications technology, also known as Long Term Evolution (LTE) technology, was designed to provide high-capacity mobile multimedia with high data rates particularly for human interaction. Next generation or fifth generation (5G) technology is intended to be used not only for human interaction, but also for machine type communications in so-called Internet of Things (IoT) networks.

While 5G networks are intended to enable massive IoT services (e.g., very large numbers of limited capacity devices) and mission-critical IoT services (e.g., requiring high reliability), improvements over legacy mobile communication services are supported in the form of enhanced mobile broadband (eMBB) services providing improved wireless Internet access for mobile devices.

In an example communication system, user equipment (5G UE in a 5G network or, more broadly, a UE) such as a mobile terminal (subscriber) communicates over an air interface with a base station or access point of an access network referred to as a 5G AN in a 5G network. The access point (e.g., gNB) is illustratively part of an access network of the communication system.

For example, in a 5G network, the access network referred to as a 5G AN is described in 5G Technical Specification (TS) 23.501, entitled “Technical Specification Group Services and System Aspects; System Architecture for the 5G System,” and TS 23.502, entitled “Technical Specification Group Services and System Aspects; Procedures for the 5G System (5GS),” the disclosures of which are incorporated by reference herein in their entireties. In general, the access point (e.g., gNB) provides access for the UE to a core network (CN or 5GC), which then provides access for the UE to other UEs and/or a data network such as a packet data network (e.g., Internet).

TS 23.501 goes on to define a 5G Service-Based Architecture (SBA) which models services as network functions (NFs) that communicate with each other using representational state transfer application programming interfaces (Restful APIs).

Furthermore, 5G Technical Specification (TS) 33.501, entitled “Technical Specification Group Services and System Aspects; Security Architecture and Procedures for the 5G System,” the disclosure of which is incorporated by reference herein in its entirety, further describes security management details associated with a 5G network.

Security management is an important consideration in any communication system. However, due to continuing attempts to improve the architectures and protocols associated with a 5G network in order to increase network efficiency and/or subscriber convenience, security management issues associated with user equipment can present a significant challenge. For example, implementing security protocols in an access network sharing environment is a technical challenge.

### SUMMARY

Illustrative embodiments provide techniques for user equipment authentication in an access network sharing environment.

In one illustrative embodiment, a method comprises establishing, via a first access management entity in a first communication network that has a radio access network associated therewith, a secure connection with a second access management entity in a second communication network to which user equipment subscribes, and facilitating, via the first access management entity, authentication of the user equipment in conjunction with the second access management entity over the secure connection to enable the user equipment to utilize the radio access network of the first communication network to access the second communication network.

In another illustrative embodiment, a method comprises establishing, via a first access management entity in a first communication network to which user equipment subscribes, a secure connection with a second access management entity in a second communication network, wherein the second communication network has a radio access network associated therewith, and facilitating, via the first access management entity, authentication of the user equipment in conjunction with the second access management entity over the secure connection to enable the user equipment to utilize the radio access network associated with the second communication network to access the first communication network.

Further illustrative embodiments are provided in the form of a non-transitory computer-readable storage medium having embodied therein executable program code that when executed by a processor causes the processor to perform the above steps. Still further illustrative embodiments comprise an apparatus with a processor and a memory configured to perform the above steps.

Advantageously, illustrative embodiments provide for user equipment authentication procedure in an access network sharing environment with an indirect connection between a participating operator's core network and a shared access network operated by another participating operator.

These and other features and advantages of embodiments described herein will become more apparent from the accompanying drawings and the following detailed description.

### BRIEF DESCRIPTION OF THE DRAWINGS

FIG. 1 illustrates a communication system with which one or more illustrative embodiments may be implemented.

FIG. 2 illustrates user equipment and entities with which one or more illustrative embodiments may be implemented.

FIG. 3 illustrates a shared access network environment with which one or more illustrative embodiments may be implemented.

FIG. 4 illustrates an architecture for access network sharing with indirect connection according to an illustrative embodiment.

FIG. 5A illustrates a protocol stack configuration for access network sharing with indirect connection according to an illustrative embodiment.

FIG. 5B illustrates a protocol stack configuration for access network sharing with indirect connection according to another illustrative embodiment.

FIG. 6A illustrates a procedure for access network sharing with indirect connection according to an illustrative embodiment.

FIG. 6B illustrates a procedure for access network sharing with indirect connection according to another illustrative embodiment.

### DETAILED DESCRIPTION

Embodiments will be illustrated herein in conjunction with example communication systems and associated techniques for security management in communication systems. It should be understood, however, that the scope of the claims is not limited to particular types of communication systems and/or processes disclosed. Embodiments can be implemented in a wide variety of other types of communication systems, using alternative processes and operations. For example, although illustrated in the context of wireless cellular systems utilizing the 3rd Generation Partnership Project (3GPP) system elements such as a 3GPP next generation system (5G), the disclosed embodiments can be adapted in a straightforward manner to a variety of other types of communication systems such as 6G communication systems.

In accordance with illustrative embodiments implemented in a 5G communication system environment, one or more 3GPP technical specifications (TS) and technical reports (TR) may provide further explanation of network elements/functions and/or operations that may interact with parts of the inventive solutions, e.g., the above-referenced 3GPP TS 23.501, TS 23.502, and TS 33.501.

Other 3GPP TS/TR documents may provide other details that one of ordinary skill in the art will realize, for example, TS 22.261 entitled “3rd Generation Partnership Project; Technical Specification Group Services and System Aspects; Service Requirements for the 5G System; Stage 1,” and TR 22.851 entitled “3rd Generation Partnership Project; Technical Specification Group TSG SA; Feasibility Study on Network Sharing Aspect,” the disclosures of which are incorporated by reference herein in their entireties.

Note that 3GPP TS/TR documents are non-limiting examples of communication network standards (e.g., specifications, procedures, reports, requirements, recommendations, and the like). However, while well-suited for 5G-related 3GPP standards, embodiments are not necessarily intended to be limited to any particular standards.

It is to be understood that the term 5G network, and the like (e.g., 5G system, 5G communication system, 5G environment, 5G communication environment, etc.), in some illustrative embodiments, may be understood to comprise all or part of an access network and all or part of a core network. However, the term 5G network, and the like, may also occasionally be used interchangeably herein with the term 5GC network, and the like, without any loss of generality, since one of ordinary skill in the art understands any distinctions.

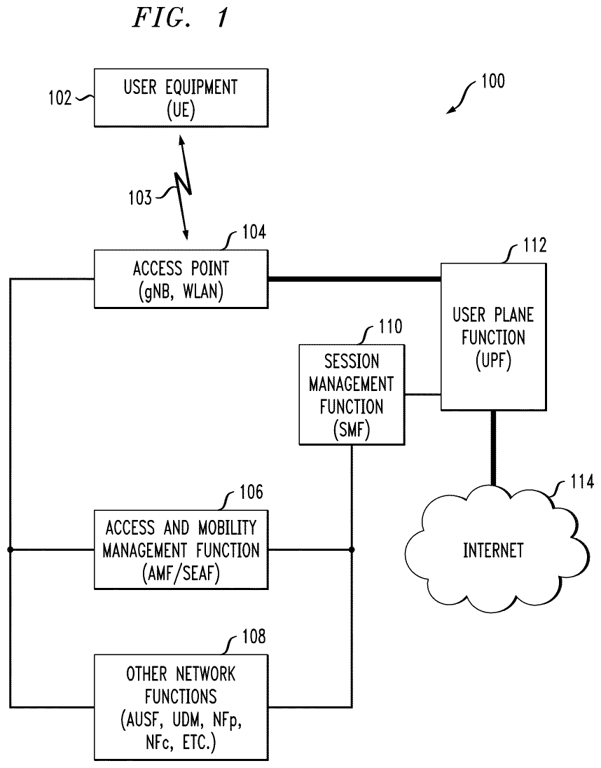

Prior to describing illustrative embodiments which focus on an access network sharing environment wherein multiple core networks (operators) share one or more access networks, a general description of certain main components of a typical 5G network will be described below in the context of FIG. 1.

FIG. 1 shows a communication system 100 within which illustrative embodiments are implemented. It is to be understood that the elements shown in communication system 100 are intended to represent some main functions provided within the system, e.g., control plane functions, user plane functions, etc. As such, the blocks shown in FIG. 1 reference specific elements in 5G networks that provide some of these main functions. However, other network elements may be used to implement some or all of the main functions represented. Also, it is to be understood that not all functions of a 5G network are depicted in FIG. 1. Rather, at least some functions that facilitate an explanation of illustrative embodiments are represented. Subsequent figures may depict some additional elements/functions (i.e., network entities).

Accordingly, as shown, communication system 100 comprises user equipment (UE) 102 that communicates via an air interface 103 with an access point 104. It is to be understood that UE 102 may use one or more other types of access points (e.g., access functions, networks, etc.) to communicate with the 5GC network other than a gNB. By way of example only, the access point 104 may be any 5G access network (gNB), an untrusted non-3GPP access network that uses an Non-3GPP Interworking Function (N3IWF), a trusted non-3GPP network that uses a Trusted Non-3GPP Gateway Function (TNGF) or wireline access that uses a Wireline Access Gateway Function (W-AGF) or may correspond to a legacy access point (e.g., eNB). Furthermore, access point 104 may be a wireless local area network (WLAN) access point as will be further explained in illustrative embodiments described herein.

The UE 102 may be a mobile station, and such a mobile station may comprise, by way of example, a mobile telephone, a computer, an IoT device, or any other type of communication device. The term “user equipment” as used herein is therefore intended to be construed broadly, so as to encompass a variety of different types of mobile stations, subscriber stations or, more generally, communication devices, including examples such as a combination of a data card inserted in a laptop or other equipment such as a smart phone. Such communication devices are also intended to encompass devices commonly referred to as access terminals.

In one illustrative embodiment, UE 102 is comprised of a Universal Integrated Circuit Card (UICC) part and a Mobile Equipment (ME) part. The UICC is the user-dependent part of the UE and contains at least one Universal Subscriber Identity Module (USIM) and appropriate application software. The USIM securely stores a permanent subscription identifier and its related key, which are used to uniquely identify and authenticate subscribers to access networks. The ME is the user-independent part of the UE and contains terminal equipment (TE) functions and various mobile termination (MT) functions. Alternative illustrative embodiments may not use UICC-based authentication, e.g., a Non-Public (Private) Network (NPN).

Note that, in one example, the permanent subscription identifier is an International Mobile Subscriber Identity (IMSI) unique to the UE. In one embodiment, the IMSI is a fixed 15-digit length and consists of a 3-digit Mobile Country Code (MCC), a 3-digit Mobile Network Code (MNC), and a 9-digit Mobile Station Identification Number (MSIN). In a 5G communication system, an IMSI is referred to as a Subscription Permanent Identifier (SUPI). In the case of an IMSI as a SUPI, the MSIN provides the subscriber identity. Thus, only the MSIN portion of the IMSI typically needs to be encrypted. The MNC and MCC portions of the IMSI provide routing information, used by the serving network to route to the correct home network. When the MSIN of a SUPI is encrypted, it is referred to as Subscription Concealed Identifier (SUCI). Another example of a SUPI uses a Network Access Identifier (NAI). NAI is typically used for IoT communication.

The access point 104 is illustratively part of a radio access network or RAN of the communication system 100. Such a radio access network may comprise, for example, a 5G System having a plurality of base stations. Components of a radio access network may, more generally, be considered “radio access entities.”

Further, the access point 104 in this illustrative embodiment is operatively coupled to an Access and Mobility Management Function (AMF/SEAF) 106. In a 5G network, the AMF/SEAF supports, inter alia, mobility management (MM) and security anchor (SEAF) functions.

AMF/SEAF 106 in this illustrative embodiment is operatively coupled to (e.g., uses the services of) other network functions 108. As shown, some of these other network functions 108 include, but are not limited to, an Authentication Server Function (AUSF) and a Unified Data Management (UDM) function. These listed network function examples are typically implemented in the home network of the UE subscriber, further explained below. Note that, in a 5GC network, the 4G function of the HSS (home subscriber server) is split into the AUSF, UDM, and a Unified Data Repository (UDR, not expressly shown) functions. Typically, AUSF authenticates UEs and provides any needed cryptographic keys, while UDR stores the user data and UDM manages the user data.

Other network functions 108 may include network functions that can act as service producers (NFp) and/or service consumers (NFc). Note that any network function can be a service producer for one service and a service consumer for another service. Further, when the service being provided includes data, the data-providing NFp is referred to as a data producer, while the data-requesting NFc is referred to as a data consumer. A data producer may also be an NF that generates data by modifying or otherwise processing data produced by another NF. Note that NFs may, more generally, be considered “network entities.”

Note that a UE, such as UE 102, is typically subscribed to what is referred to as a Home Public Land Mobile Network (HPLMN) in which some or all of the functions 106 and 108 reside. Alternatively the UE, such as UE 102, may receive services from an NPN where these functions may reside. The HPLMN is also referred to as the Home Environment (HE) or Home Network (HN). If the UE is roaming (not in the HPLMN), it is typically connected with a Visited Public Land Mobile Network (VPLMN) also referred to as a visited network, while the network that is currently serving the UE is also referred to as a serving network. In the roaming case, some of the network functions 106 and 108 can reside in the VPLMN, in which case, functions in the VPLMN communicate with functions in the HPLMN as needed. However, in a non-roaming scenario, mobility management functions 106 and the other network functions 108 reside in the same communication network, i.e., HPLMN. Embodiments described herein, unless otherwise specified, are not necessarily limited by which functions reside in which PLMN (i.e., HPLMN or VPLMN).

The access point 104 is also operatively coupled (via one or more of functions 106 and/or 108) to a Session Management Function (SMF) 110, which is operatively coupled to a User Plane Function (UPF) 112. UPF 112 is operatively coupled to a Packet Data Network, e.g., Internet 114. Note that the thicker solid lines in this figure denote a user plane (UP) of the communication network, as compared to the thinner solid lines that denote a control plane (CP) of the communication network. It is to be appreciated that network (e.g., Internet) 114 in FIG. 1 may additionally or alternatively represent other network infrastructures including, but not limited to, cloud computing infrastructure and/or edge computing infrastructure. Further typical operations and functions of such network elements are not described here since they are not the focus of the illustrative embodiments and may be found in appropriate 3GPP 5G documentation. Note that functions shown in 106, 108, 110 and 112 are examples of network functions (NFs).

It is to be appreciated that this particular arrangement of system elements is an example only, and other types and arrangements of additional or alternative elements can be used to implement a communication system in other embodiments. For example, in other embodiments, the communication system 100 may comprise other elements/functions not expressly shown herein.

Accordingly, the FIG. 1 arrangement is just one example configuration of a wireless cellular system, and numerous alternative configurations of system elements may be used. For example, although only single elements/functions are shown in the FIG. 1 embodiment, this is for simplicity and clarity of description only. A given alternative embodiment may of course include larger numbers of such system elements, as well as additional or alternative elements of a type commonly associated with conventional system implementations.

It is also to be noted that while FIG. 1 illustrates system elements as singular functional blocks, the various subnetworks that make up the 5G network are partitioned into so-called network slices. Network slices (network partitions) are logical networks that provide specific network capabilities and network characteristics that can support a corresponding service type, optionally using network function virtualization (NFV) on a common physical infrastructure. With NFV, network slices are instantiated as needed for a given service, e.g., eMBB service, massive IoT service, and mission-critical IoT service. A network slice or function is thus instantiated when an instance of that network slice or function is created. In some embodiments, this involves installing or otherwise running the network slice or function on one or more host devices of the underlying physical infrastructure. UE 102 is configured to access one or more of these services via access point 104.

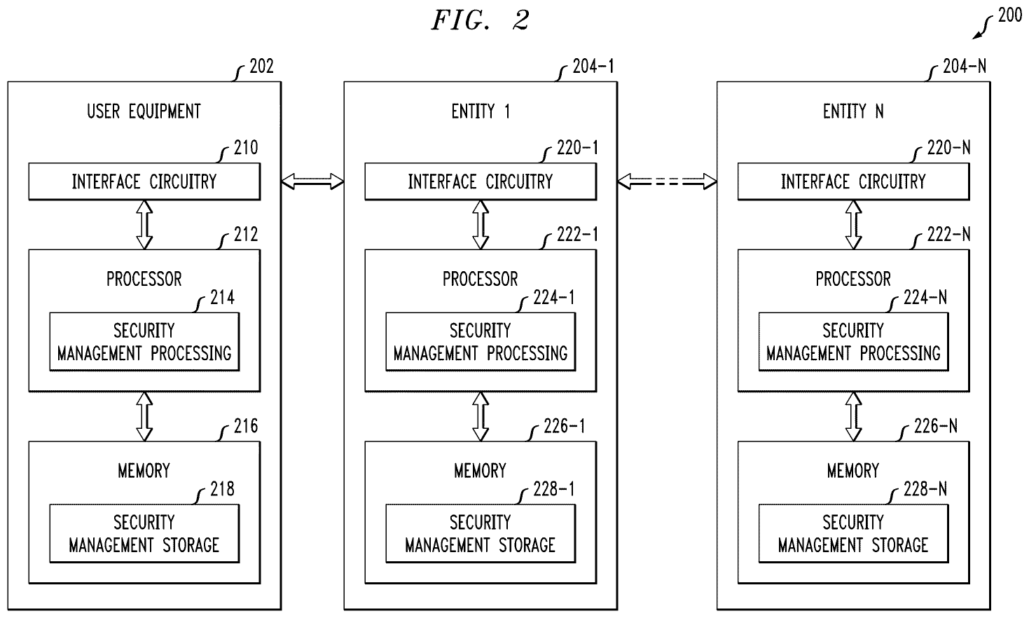

FIG. 2 is a block diagram illustrating computing architectures for various participants in methodologies according to illustrative embodiments. More particularly, system 200 is shown comprising user equipment (UE) 202 and a plurality of entities 204-1, . . . , 204-N. For example, in illustrative embodiments and with reference back to FIG. 1, UE 202 can represent UE 102, while entities 204-1, . . . , 204-N can represent functions 106 and 108 (i.e., network entities), as well as access point 104 (i.e., radio access entity). It is to be appreciated that the UE 202 and entities 204-1, . . . , 204-N are configured to interact to provide security management and other techniques described herein.

The user equipment 202 comprises a processor 212 coupled to a memory 216 and interface circuitry 210. The processor 212 of the user equipment 202 includes a security management processing module 214 that may be implemented at least in part in the form of software executed by the processor. The security management processing module 214 performs security management described in conjunction with subsequent figures and otherwise herein. The memory 216 of the user equipment 202 includes a security management storage module 218 that stores data generated or otherwise used during security management operations.

Each of the entities (individually or collectively referred to herein as 204) comprises a processor 222 (222-1, . . . , 222-N) coupled to a memory 226 (226-1, . . . , 226-N) and interface circuitry 220 (220-1, . . . , 220-N). Each processor 222 of each entity 204 includes a security management processing module 224 (224-1, . . . , 224-N) that may be implemented at least in part in the form of software executed by the processor 222. The security management processing module 224 performs security management operations described in conjunction with subsequent figures and otherwise herein. Each memory 226 of each entity 204 includes a security management storage module 228 (228-1, . . . , 228-N) that stores data generated or otherwise used during security management operations.

The processors 212 and 222 may comprise, for example, microprocessors such as central processing units (CPUs), application-specific integrated circuits (ASICs), digital signal processors (DSPs) or other types of processing devices, as well as portions or combinations of such elements.

The memories 216 and 226 may be used to store one or more software programs that are executed by the respective processors 212 and 222 to implement at least a portion of the functionality described herein. For example, security management operations and other functionality as described in conjunction with subsequent figures and otherwise herein may be implemented in a straightforward manner using software code executed by processors 212 and 222.

A given one of the memories 216 and 226 may therefore be viewed as an example of what is more generally referred to herein as a computer program product or still more generally as a processor-readable storage medium that has executable program code embodied therein. Other examples of processor-readable storage media may include disks or other types of magnetic or optical media, in any combination. Illustrative embodiments can include articles of manufacture comprising such computer program products or other processor-readable storage media.

Further, the memories 216 and 226 may more particularly comprise, for example, electronic random-access memory (RAM) such as static RAM (SRAM), dynamic RAM (DRAM) or other types of volatile or non-volatile electronic memory. The latter may include, for example, non-volatile memories such as flash memory, magnetic RAM (MRAM), phase-change RAM (PC-RAM) or ferroelectric RAM (FRAM). The term “memory” as used herein is intended to be broadly construed, and may additionally or alternatively encompass, for example, a read-only memory (ROM), a disk-based memory, or other type of storage device, as well as portions or combinations of such devices.

The interface circuitries 210 and 220 illustratively comprise transceivers or other communication hardware or firmware that allows the associated system elements to communicate with one another in the manner described herein.

It is apparent from FIG. 2 that user equipment 202 and plurality of entities 204 are configured for communication with each other as security management participants via their respective interface circuitries 210 and 220. This communication involves each participant sending data to and/or receiving data from one or more of the other participants. The term “data” as used herein is intended to be construed broadly, so as to encompass any type of information that may be sent between participants including, but not limited to, identity data, key pairs, key indicators, tokens, secrets, security management messages, registration request/response messages and data, request/response messages, authentication request/response messages and data, metadata, control data, audio, video, multimedia, consent data, other messages, etc.

It is to be appreciated that the particular arrangement of components shown in FIG. 2 is an example only, and numerous alternative configurations may be used in other embodiments. For example, any given network element/function and/or access point can be configured to incorporate additional or alternative components and to support other communication protocols.

Other system elements such as access point 104, SMF 110, and UPF 112 may each be configured to include components such as a processor, memory, and network interface. These elements need not be implemented on separate stand-alone processing platforms, but could instead, for example, represent different functional portions of a single common processing platform.

More generally, FIG. 2 can be considered to represent processing devices configured to provide respective security management functionalities and operatively coupled to one another in a communication system.

As mentioned above, the 3GPP TS 23.501 defines the 5GC network architecture as service-based, e.g., Service-Based Architecture (SBA). It is realized herein that in deploying different NFs, there can be many situations where an NF may need to interact with an entity external to the SBA-based 5GC network (e.g., including the corresponding PLMN(s), e.g., HPLMN and VPLMN). Thus, the term “internal” as used herein illustratively refers to operations and/or communications within the SBA-based 5GC network (e.g., SBA-based interfaces) and the term “external” illustratively refers to operations and/or communications outside the SBA-based 5GC network (non-SBA interfaces).

Given the above general description of some features of a 5GC network, problems with existing security approaches in the context of access network sharing, and solutions proposed in accordance with illustrative embodiments, will now be described herein below.

As stated in the above-referenced TS 22.261, the increased density of access nodes (e.g., wherein an access point such as access point 104 in FIG. 1 is a non-limiting example of an access node) needed to meet expanding performance objectives pose considerable challenges in deployment and acquiring spectrum and antenna locations. Access network (radio access network or RAN) sharing is seen as a technical solution to these issues.

Sharing access networks and network infrastructure has increasingly become an important part of 3GPP systems. When two or more operators have respectively deployed or plan to deploy 5G access networks and core networks, a Multi-Operator Core Network (MOCN) configuration can be considered for network sharing between these operators. For example, an MOCN can comprise multiple core network (CN) nodes (e.g., 5GC network entities) connected to the same radio access network, while CN nodes are operated by different operators.

One of the challenges for the network operators sharing an access network is the maintenance generated by the interconnection (e.g., number of network interfaces) between the shared RAN and two or more core networks, especially for a large number of shared base stations.

It is therefore realized that other types of network sharing configurations should be considered such as, for example, where a 5G RAN is shared among multiple operators without necessarily assuming a direct connection between a shared access network and the core networks of the participating operators.

By way of example, assume two (or more) operators provide coverage with their respective radio access networks in different parts of a country but together cover the entire country. Further assume there is an agreement between all the operators to work together and to build a shared network (e.g., MOCN) but while utilizing the different operator's allocated spectrum appropriately in different parts of the coverage area, e.g., Low Traffic Areas (LTA) and High Traffic Areas (HTA).

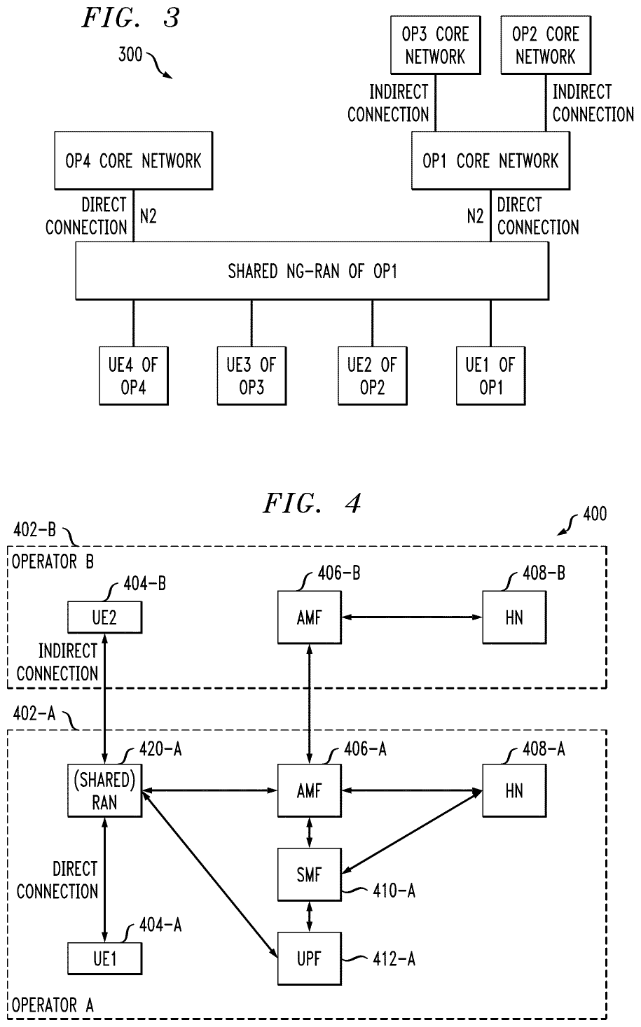

An example of a shared access network environment 300 is illustrated in FIG. 3. More particularly, as shown, core networks of multiple operators, e.g., OP1, OP2, OP3 and OP4, share the NG-RAN owned and operated by OP1 (thus OP1 can be referred to as the “hosting RAN operator”). The other OPs can share NG-RAN of OP1 with or without direct connections between the shared access network and the core networks of the OPs. For example, as shown, in addition to the core network of OP1 using a direct connection (i.e., via the N2 interface) with its own NG-RAN, the core network of OP4 also utilizes a direct (N2) connection. OP4 is considered to have an MOCN arrangement with OP1. In contrast, the core networks of OP2 and OP3 respectively utilize indirect connections with the NG-RAN via the core network of OP1, as will be further explained. Thus, each UE subscribing to a particular core network operator, e.g., as shown, UE1 of OP1, UE2 of OP2, UE3 of OP3, and UE4 of OP4, accesses their corresponding core network via the shared NG-RAN of OP1. Further to the above assumptions, in this example, further assume NG-RAN is shared with certain conditions, e.g., within a specific 5G frequency band or within a specific area.

Given the shared access network environment 300 in FIG. 3, the following service flows can occur. UE1 can successfully attach to NG-RAN, and the display of the network operator name is the name of OP1. UE2 can successfully attach to NG-RAN, and the display of the network operator name is the name of OP2. UE3 can successfully attach to NG-RAN, and the display of the network operator name is the name of OP3. UE4 can successfully attach to NG-RAN, and the display of the network operator name is the name of OP4. The service provider of UE 1 is OP1. The service provider of UE 2 is OP2. The service provider of UE 3 is OP3.

The service provider of UE 4 is OP4. For UEs accessing the shared RAN, the network of the hosting operator (e.g., OP1) needs to know which participating operator a UE is registered to and what type of network sharing (e.g., MOCN or otherwise) is in place for that participating operator. In this type of network sharing, the UE is not aware of the type and details of the network sharing, i.e., UE procedures are transparent to the network sharing. The UE connects and registers as if it is connecting to one single network belonging to its home operator.

Thus, in certain scenarios as illustrated in the FIG. 3 example, it is desirable for the 5G system to support access network sharing with indirect connection between the shared access network (e.g., NG-RAN of OP1) and one or more participating operators' core networks (e.g., OP2 and OP3).

However, it is realized herein that with network sharing via an indirect connection, an authentication procedure is not currently available, particularly one that does not impact a UE.

Illustrative embodiments overcome the above and other technical drawbacks associated with existing access network sharing approaches by providing a UE authentication procedure in an access network sharing environment with an indirect connection between a participating operator's core network and a shared access network operated by another participating operator.

In access network sharing with an indirect connection, it is realized herein that the UE should be transparent to the network configuration and involvement of two or more PLMNs in offering the service. However, the UE assumes it is connected to a single PLMN while performing Non-Access Stratum (NAS) and Access Stratum (AS) procedures.

To preserve this homogeneity of the serving PLMN in access network sharing and to keep the UE transparent to the access network sharing, one or more illustrative embodiments adapt network behavior and one or more protocol stacks in the network. More particularly, one or more illustrative embodiments extend a legacy authentication procedure to support indirect connection between a shared RAN and a core network of a participating operator.

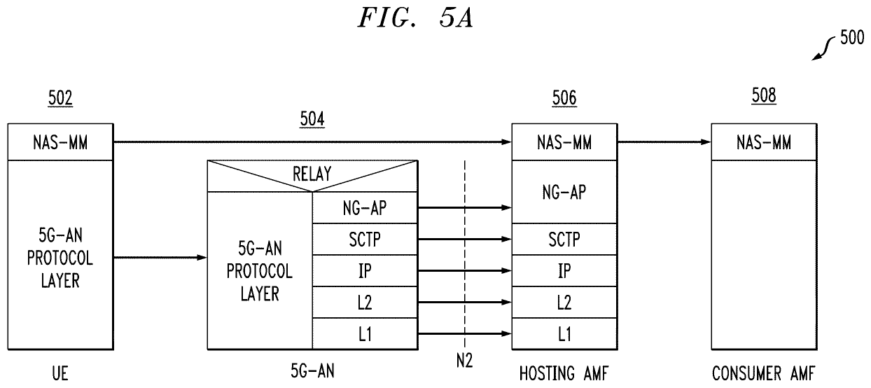

For example, FIG. 4 illustrates an architecture 400 according to an illustrative embodiment. As shown, an operator 402-A (Operator A) has associated therewith a UE 404-A (UE1), an AMF 406-A, an HN 408-A, an SMF 410-A, a UPF 412-A, and a (shared) RAN 420-A. It is to be understood that HN 408-A comprises one or more network entities (e.g., AUSF, UDM, UDR, etc.) that are part of the core network of operator 402-A to which UE 404-A subscribes. As further shown, an operator 402-B (Operator B) has associated therewith a UE 404-B (UE2), an AMF 406-B, and an HN 408-B. It is to be understood that HN 408-B comprises one or more network entities (e.g., AUSF, UDM, UDR, etc.) that are part of the core network of operator 402-B to which UE 404-B subscribes.

AMF 406-A from the core network of operator 402-A, which has a direct connection with the (shared) RAN 420-A, can be considered a “hosting AMF.” AMF 406-B from the core network of operator 402-B, which has an indirect connection with the (shared) RAN 420-A, can be considered a “consumer AMF.” Thus, in a direct connection scenario, UE 404-A is served by (shared) RAN 420-A, AMF 406-A, SMF 410-A, UPF 412-A, and HN 408-A of operator 402-A. In an indirect connection scenario, UE 404-B is being served by (shared) RAN 420-A, hosting AMF 406-A, SMF 410-A, and UPF 412-A which support operator 402-B's core network entities such as AMF 406-B and HN 408-B. Advantageously, as will be further explained herein, illustrative embodiments provide for communication between the hosting AMF and the consumer AMF to extend a legacy authentication procedure to support indirect connection based on (shared) RAN 420-A. AMFs may also be referred to herein as “access management entities.”

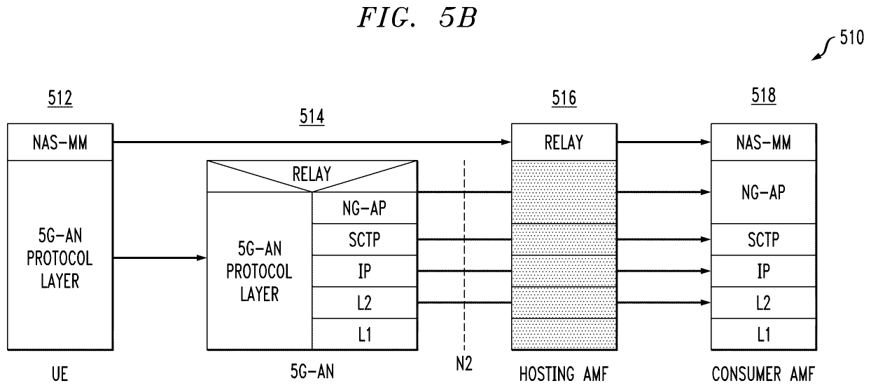

Furthermore, with regard to protocol stacks according to one illustrative embodiment, the hosting AMF acts as a main AMF (also referred to herein as a “primary access management entity”) holding the UE context and the consumer AMF co-ordinates between HN network entities and the hosting AMF to obtain keys and configurations. This is illustrated in protocol stack configuration 500 of FIG. 5A with respect to a protocol stack 502 for UE 404-B, a protocol stack 504 for the (shared) RAN 420-A (5G-RAN), a protocol stack 506 for the hosting AMF 406-A, and a protocol stack 508 for the consumer AMF 406-B.

In another illustrative embodiment, the hosting AMF acts as a relay AMF, where all the NAS messages are relayed to the consumer AMF or home network AMF acting as a main AMF (also referred to herein as a “primary access management entity”) holding the UE context. This is illustrated in protocol stack configuration 510 of FIG. 5B with respect to a protocol stack 512 for UE 404-B, a protocol stack 514 for the (shared) RAN 420-A (5G-RAN), a protocol stack 516 for the hosting AMF 406-A, and a protocol stack 518 for the consumer AMF 406-B.

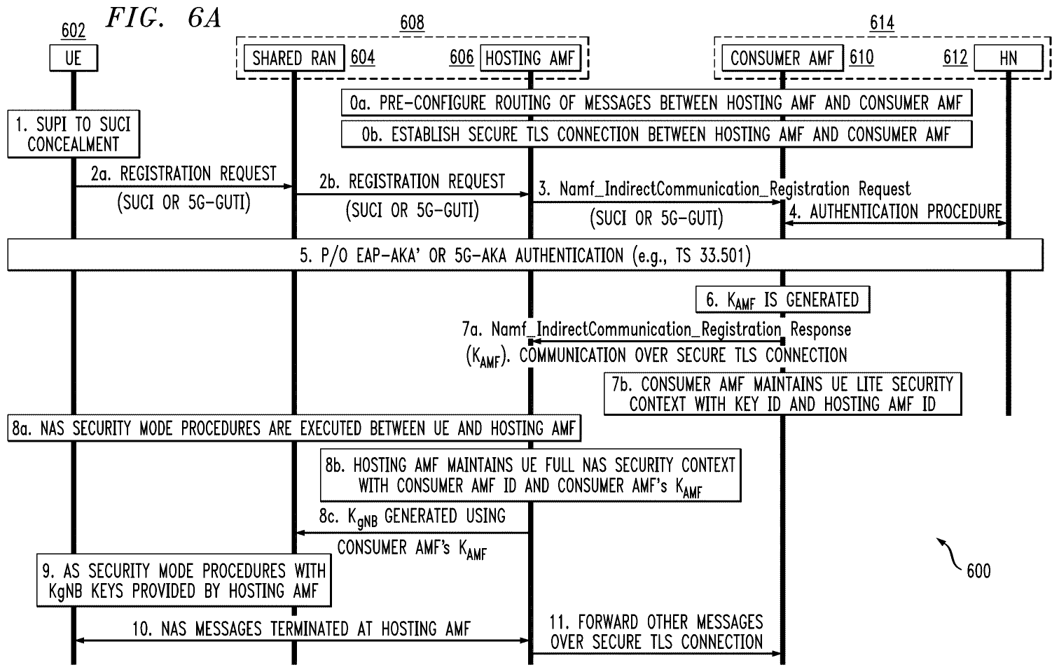

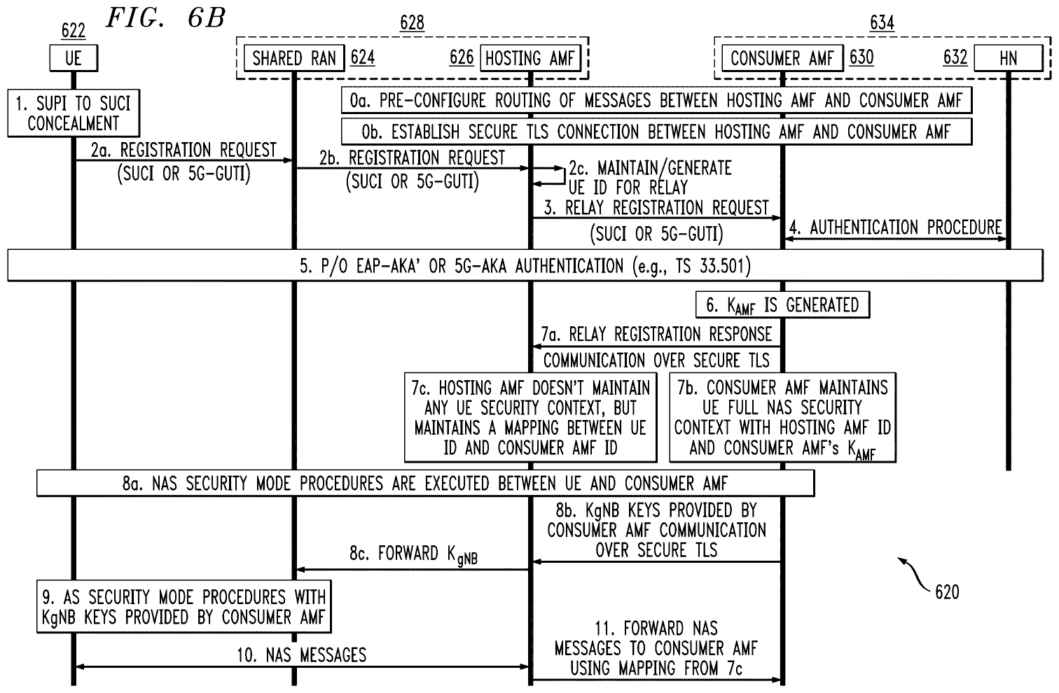

Thus, with respect to authentication, one AMF acts as a hosting AMF and another AMF acts as a consumer AMF. In one illustrative embodiment, hosting AMF acts as a relay AMF which will be further illustrated below in the context of FIG. 6A (consistent with protocol stack configuration 500 of FIG. 5A), and in another illustrative embodiments, the hosting AMF acts as main AMF which will be further illustrated below in the context of FIG. 6B (consistent with protocol stack configuration 510 of FIG. 5B). UE context is maintained in the AMF (hosting AMF or consumer AMF) according to the embodiment supported. Mapping of the UE identifier (ID) with the consumer AMF is done by the hosting AMF for future relaying of messages. The hosting AMF and the consumer AMF may each be generally referred to herein as an “access management entity.”

Referring now to FIG. 6A, a procedure 600 is depicted for user equipment authentication in an access network sharing environment according to an illustrative embodiment. Procedure 600 corresponds to protocol stack configuration 500 of FIG. 5A. As shown, procedure 600 involves a UE 602, a shared radio access network (shared RAN) 604 and a hosting AMF 606 of a network operator 608, and a consumer AMF 610 and a home network (HN) 612 of a network operator 614 to which UE 602 is subscribed.

Step 0 (a. and b.). The hosting AMF 606 and the consumer AMF 610 are respectively pre-configured for routing messages therebetween. Also, a Transport Layer Security (TLS) connection between the hosting AMF 606 and the consumer AMF 610 is established.

Steps 1 and 2 (a. and b.). UE 602 performs SUPI to SUCI concealment, and a Registration Request message is sent with the SUCI or 5G Globally Unique Temporary Identifier (5G-GUTI) from UE 602 to hosting AMF 606 via the shared RAN.

Step 3. The hosting AMF 606 sends a new service-based interface (SBI) message, i.e., Namf_IndirectCommunication_Registration Request message, with the SUCI or 5G-GUTI to consumer AMF 610.

Steps 4 and 5. Authentication procedures including authentication and key management challenges are executed as described in the above-referenced TS 33.501 (e.g., see FIG. 6.1.3.1-1 or 6.1.3.2-1, steps 3 to 12 of TS 33.501 where 5G Authentication and Key Agreement (5G AKA) and Extensible Authentication Protocol AKA (EAP-AKA′) are described).

Step 6. The key KAMF is generated in the consumer AMF 610.

Step 7 (a. and b.). The consumer AMF 610 responds with a Namf_IndirectCommunication_Registration response with the generated key KAMF. Communication occurs over the secured TLS connection between the hosting AMF 606 and the consumer AMF 610. The consumer AMF 610 maintains a UE lite security context with key ID and hosting AMF ID.

Step 8 (a., b., and c.). The hosting AMF 606 is the main AMF which maintains the complete UE full NAS security context with the consumer AMF (610) ID and the key KAMF. The NAS security mode procedures are executed between UE 602 and hosting AMF 606. The hosting AMF 606 generates the gNB key KgNB using KAMF of the consumer AMF 610 and sends it to the gNB of shared RAN 604.

Steps 9, 10 and 11. The AS security mode procedure is executed with the received KgNB key provided by hosting AMF 606. NAS messages are terminated at hosting AMF 606 and the rest of the messages are forwarded to HN 612 via consumer AMF 610.

Referring now to FIG. 6B, a procedure 620 is depicted for user equipment authentication in an access network sharing environment according to an illustrative embodiment. Procedure 620 corresponds to protocol stack configuration 510 of FIG. 5B. As shown, procedure 620 involves a UE 622, a shared radio access network (shared RAN) 624 and a hosting AMF 626 of a network operator 628, and a consumer AMF 630 and a home network (HN) 632 of a network operator 634 to which UE 622 is subscribed.

Step 0 (a. and b.). The hosting AMF 626 and the consumer AMF 630 are pre-configured for routing messages therebetween.

Steps 1 and 2 (a., b., and c.). UE 622 performs SUPI to SUCI concealment. A Registration Request message is sent with the SUCI or 5G-GUTI from UE 622 to the hosting AMF 626. The hosting AMF 626 maintains or generates the UE (622) ID for relaying to the consumer AMF 630.

Step 3. The hosting AMF 626 sends a Relay Registration Request message with SUCI or 5G-GUTI to the consumer AMF 630.

Steps 4 and 5. Authentication procedures including authentication and key management challenges are executed as described in the above-referenced TS 33.501 (e.g., see FIG. 6.1.3.1-1 or 6.1.3.2-1, steps 3 to 12 of TS 33.501 where 5G Authentication and Key Agreement (5G AKA) and Extensible Authentication Protocol AKA (EAP-AKA′) are described).

Step 6. The key KAMF is generated in the consumer AMF 630.

Step 7 (a., b., and c.). The consumer AMF 630 responds with a Relay Registration response over the secured TLS connection between the hosting AMF 626 and the consumer AMF 630. The consumer AMF 630 maintains the UE full NAS security context with Key ID and the hosting AMF (626) ID. The hosting AMF 626 does not maintain any UE security context but maintains a mapping between UE (622) ID and the consumer AMF (630) ID.

Step 8 (a., b., and c.). The NAS security mode procedures are executed between UE 622 and the consumer AMF 630. The consumer AMF 630 generates gNB key KgNB using the key KAMF of the consumer AMF 630 and sends the generated key KgNB to the hosting AMF 626. The hosting AMF 626 relays the generated key KgNB to the gNB of the shared RAN 624.

Steps 9, 10 and 11. The AS security mode procedure is executed with the received KgNB key provided by the hosting AMF 626. NAS messages are terminated at the hosting AMF 626 and the rest of the messages are forwarded to HN 632 via the consumer AMF 630.

Advantageously, as illustratively explained herein, illustrative embodiments provide authentication solutions in an access network sharing environment for indirect connection scenarios. Further, by way of advantage, illustrative embodiments impact the AMFs (hosting and consumer AMFs) in order to enable communications there between. Thus, the gNB and the UE can retain the legacy procedures (as in the case of current RAN sharing) and need not be modified to implement the authentication solutions described herein to support direct or indirect network sharing.

For example, in some embodiments from a hosting AMF perspective, an apparatus comprises at least one processor and at least one memory storing instructions that, when executed by the at least one processor, cause the apparatus to be configured as a first access management entity in a first communication network, wherein the first communication network has a radio access network associated therewith. The first access management entity is configured to: establish a secure connection with a second access management entity in a second communication network to which user equipment subscribes; and facilitate authentication of the user equipment in conjunction with the second access management entity over the secure connection to enable the user equipment to utilize the radio access network associated with the first communication network to access the second communication network.

The hosting AMF may function as a main (primary) AMF. For example, when facilitating authentication of the user equipment, the first access management entity may further be configured as a primary access management entity that maintains a security context of the user equipment. As such, the first access management entity may further be configured to one or more of: receive a first key from the second access management entity; perform one or more non-access stratum security procedures with the user equipment; generate a second key based on the first key received from the second access management entity; and send the second key to the radio access network to enable the radio access network and the user equipment to perform one or more access stratum security procedures.

The hosting AMF may function as a relay AMF. For example, when facilitating authentication of the user equipment, the first access management entity may further be configured as a relay access management entity that relays messages to the second access management entity that is configured as a primary access management entity that maintains a security context of the user equipment. As such, the first access management entity may further be configured to one or more of: maintain a mapping between an identifier of the user equipment and an identifier of the second access management entity; receive a key from the second access management entity; and send the key to the radio access network to enable the radio access network and the user equipment to perform one or more access stratum security procedures.

For example, in some embodiments from a consumer AMF perspective, an apparatus comprises at least one processor and at least one memory storing instructions that, when executed by the at least one processor, cause the apparatus to be configured as a first access management entity in a first communication network to which user equipment subscribes. The first access management entity is configured to: establish a secure connection with a second access management entity in a second communication network, wherein the second communication network has a radio access network associated therewith; and facilitate authentication of the user equipment in conjunction with the second access management entity over the secure connection to enable the user equipment to utilize the radio access network associated with the second communication network to access the first communication network.

The consumer AMF may function as a main (primary) AMF. For example, when facilitating authentication of the user equipment, the first access management entity may further be configured as a primary access management entity that maintains a security context of the user equipment. As such, the first access management entity may further be configured to one or more of: perform one or more non-access stratum security procedures with the user equipment; generate a key to enable the radio access network and the user equipment to perform one or more access stratum security procedures; and send the key to second access management entity for forwarding to the radio access network.

The consumer AMF may function as a secondary AMF. For example, when facilitating authentication of the user equipment, the first access management entity may further be configured to assist with key management for the second access management entity that is configured as a primary access management entity that maintains a security context of the user equipment. As such, the first access management entity may further be configured to one or more of: generate a first key; and send the first key to the second access management entity to enable the second access management entity to generate a second key based on the first key, wherein the second key is usable to enable the radio access network and the user equipment to perform one or more access stratum security procedures.

For example, in some embodiments from user equipment perspective, an apparatus comprises at least one processor and at least one memory storing instructions that, when executed by the at least one processor, cause the apparatus to perform one or more procedures with one of: (i) a first access management entity in a first communication network that has a radio access network associated therewith; and (ii) a second access management entity in a second communication network to which the apparatus is subscribed, to enable the apparatus to utilize the radio access network associated with the first communication network to access the second communication network. The apparatus, while performing the one or more procedures with the first access management entity, the second access management entity network, or any other network entities belonging to the first communication network or the second communication network, functions as if it is communicating with a single communication network without differentiating between the first communication network and the second communication network.

For example, in some embodiments from a shared radio access network perspective, an apparatus comprises at least one processor and at least one memory storing instructions that, when executed by the at least one processor, cause the apparatus to participate in one or more procedures involving: (i) a first access management entity in a first communication network with which the apparatus is associated; and (ii) a second access management entity in a second communication network to which user equipment is subscribed, to enable the user equipment to utilize the apparatus to access the second communication network.

As used herein, it is to be understood that the term “communication network” in some embodiments can comprise two or more separate communication networks. Further, the particular processing operations and other system functionality described in conjunction with the diagrams described herein are presented by way of illustrative example only and should not be construed as limiting the scope of the disclosure in any way. Alternative embodiments can use other types of processing operations and messaging protocols. For example, the ordering of the steps may be varied in other embodiments, or certain steps may be performed at least in part concurrently with one another rather than serially. Also, one or more of the steps may be repeated periodically, or multiple instances of the methods can be performed in parallel with one another.

It should again be emphasized that the various embodiments described herein are presented by way of illustrative example only and should not be construed as limiting the scope of the claims. For example, alternative embodiments can utilize different communication system configurations, user equipment configurations, base station configurations, provisioning and usage processes, messaging protocols and message formats than those described above in the context of the illustrative embodiments. These and numerous other alternative embodiments within the scope of the appended claims will be readily apparent to those skilled in the art.

1. An apparatus comprising:
at least one processor; and
at least one memory storing instructions that, when executed by the at least one processor, cause the apparatus to be configured as a first access management entity in a first communication network, wherein the first communication network has a radio access network associated therewith, the first access management entity being configured to:
establish a secure connection with a second access management entity in a second communication network to which user equipment subscribes; and
facilitate authentication of the user equipment in conjunction with the second access management entity over the secure connection to enable the user equipment to utilize the radio access network associated with the first communication network to access the second communication network.

2. The apparatus of claim 1, wherein, when facilitating authentication of the user equipment, the first access management entity is further configured as a primary access management entity that maintains a security context of the user equipment.

3. The apparatus of claim 2, wherein, when facilitating authentication of the user equipment, the first access management entity is further configured to receive a first key from the second access management entity.

4. The apparatus of claim 3, wherein, when facilitating authentication of the user equipment, the first access management entity is further configured to perform one or more non-access stratum security procedures with the user equipment.

5. The apparatus of claim 3, wherein, when facilitating authentication of the user equipment, the first access management entity is further configured to generate a second key based on the first key received from the second access management entity.

6. The apparatus of claim 5, wherein, when facilitating authentication of the user equipment, the first access management entity is further configured to send the second key to the radio access network to enable the radio access network and the user equipment to perform one or more access stratum security procedures.

7. The apparatus of claim 1, wherein, when facilitating authentication of the user equipment, the first access management entity is further configured as a relay access management entity that relays messages to the second access management entity that is configured as a primary access management entity that maintains a security context of the user equipment.

8. The apparatus of claim 7, wherein, when facilitating authentication of the user equipment, the first access management entity is further configured to maintain a mapping between an identifier of the user equipment and an identifier of the second access management entity.

9. The apparatus of claim 8, wherein, when facilitating authentication of the user equipment, the first access management entity is further configured to:
receive a key from the second access management entity; and
send the key to the radio access network to enable the radio access network and the user equipment to perform one or more access stratum security procedures.

10. A method comprising:
establishing, via a first access management entity in a first communication network that has a radio access network associated therewith, a secure connection with a second access management entity in a second communication network to which user equipment subscribes; and
facilitating, via the first access management entity, authentication of the user equipment in conjunction with the second access management entity over the secure connection to enable the user equipment to utilize the radio access network of the first communication network to access the second communication network.

11. A non-transitory computer-readable storage medium having embodied therein executable program code that when executed by a processor causes the processor to perform the method of claim 10.

12. An apparatus comprising:
at least one processor; and
at least one memory storing instructions that, when executed by the at least one processor, cause the apparatus to be configured as a first access management entity in a first communication network to which user equipment subscribes, the first access management entity being configured to:
establish a secure connection with a second access management entity in a second communication network, wherein the second communication network has a radio access network associated therewith; and
facilitate authentication of the user equipment in conjunction with the second access management entity over the secure connection to enable the user equipment to utilize the radio access network associated with the second communication network to access the first communication network.

13. The apparatus of claim 12, wherein, when facilitating authentication of the user equipment, the first access management entity is further configured as a primary access management entity that maintains a security context of the user equipment.

14. The apparatus of claim 13, wherein, when facilitating authentication of the user equipment, the first access management entity is further configured to perform one or more non-access stratum security procedures with the user equipment.

15. The apparatus of claim 14, wherein, when facilitating authentication of the user equipment, the first access management entity is further configured to generate a key to enable the radio access network and the user equipment to perform one or more access stratum security procedures.

16. The apparatus of claim 15, wherein, when facilitating authentication of the user equipment, the first access management entity is further configured to send the key to second access management entity for forwarding to the radio access network.

17. The apparatus of claim 12, wherein, when facilitating authentication of the user equipment, the first access management entity is further configured to assist with key management for the second access management entity that is configured as a primary access management entity that maintains a security context of the user equipment.

18. The apparatus of claim 17, wherein, when facilitating authentication of the user equipment, the first access management entity is further configured to generate a first key.

19. The apparatus of claim 18, wherein, when facilitating authentication of the user equipment, the first access management entity is further configured to send the first key to the second access management entity to enable the second access management entity to generate a second key based on the first key, wherein the second key is usable to enable the radio access network and the user equipment to perform one or more access stratum security procedures.

20. A method comprising:
establishing, via a first access management entity in a first communication network to which user equipment subscribes, a secure connection with a second access management entity in a second communication network, wherein the second communication network has a radio access network associated therewith; and
facilitating, via the first access management entity, authentication of the user equipment in conjunction with the second access management entity over the secure connection to enable the user equipment to utilize the radio access network associated with the second communication network to access the first communication network.
